(19) United States
(12) Patent Application Publication
(10) Pub. No.: US 2013/0242138 A1
(43) Pub. Date: Sep. 19, 2013

(54) ENHANCED RESOLUTION IMAGE CAPTURE

(71) Applicants: Axel Becker-Lakus, San Jose, CA (US); Ankit Mohan, Santa Clara, CA (US)

(72) Inventors: Axel Becker-Lakus, San Jose, CA (US); Ankit Mohan, Santa Clara, CA (US)

(73) Assignee: CANON KABUSHIKI KAISHA, Tokyo (JP)

(21) Appl. No.: 13/421,719

(22) Filed: Mar. 15, 2012

(51) Int. Cl. H04N 5/262

(52) U.S. Cl. 348/239; 348/E05.051

(57) ABSTRACT

First and second images of a scene are captured using respectively different first and second optical paths. The first optical path includes an optical element comprising a stack of microlens arrays. A synthesized image of the scene is generated by calculations using the first and second captured images of the scene. The synthesized image has improved image characteristics as compared to both of the first captured image and the second captured image.

### FIELD

The present disclosure relates to image capture, and more particularly relates to synthesizing an image with enhanced resolution from captured image data.

### BACKGROUND

In the field of image capture systems, one area of research is in improving the versatility of such systems.

### SUMMARY

In an effort to improve versatility of image capture systems, the inventors herein have conducted research into reconfigurable soft optics, i.e., optics which allow reconfiguration of characteristics of image capture without significant reconfiguration of the physical capture hardware. In such systems, for example, one item of capture hardware can be reconfigured for multiple different configurations, such as multiple different optical properties controlled by application of a configuration parameter to the item of capture hardware.

In the course of their research into soft optics, the inventors have investigated the use of an optical element comprising a stack of microlens arrays. One example of a stack of microlens arrays is a Gabor superlens. A Gabor superlens was described a UK patent in the 1940's, namely GB541753, and was built and benchmarked in 1999.

In some cases, the stack of microlens arrays is itself not reconfigurable, but in such cases it can still be used in reconfigurable capture systems by combining it with other items of capture hardware which are reconfigurable. In other cases, the stack of microlens arrays is itself mechanically (or otherwise) reconfigurable. For example, the stack of microlens arrays might include one or two tunable microlens arrays comprised of liquid crystal lenslets, such that the focal length can be varied.

One difficulty with optical elements such as the stack of microlens arrays is that such elements can tend to have poor resolution, and may in fact have resolution that is inhomogeneous across the field of view.

The foregoing situation is addressed through an image capture system which combines first and second images captured using respectively different first and second optical paths to generate a synthesized image with improved image characteristics, wherein at least one path includes a stack of microlens arrays.

Thus, in an example embodiment described herein, first and second images of a scene are captured using respectively different first and second optical paths. The first optical path includes an optical element comprising a stack of microlens arrays. A synthesized image of the scene is generated by calculations using the first and second captured images of the scene. The synthesized image has improved image characteristics as compared to both of the first captured image and the second captured image.

By combining first and second images captured using first and second optical paths to generate a synthesized image, it is ordinarily possible to utilize optical elements such as the Gabor superlens while improving image characteristics such as resolution.

In some example embodiments, the first and second optical paths are defined by a beam splitter which splits the first and second optical paths into physically different optical paths. In other example embodiments, the first and second captured images are captured in succession by an image sensor used commonly for both of the first and second optical paths.

This brief summary has been provided so that the nature of this disclosure may be understood quickly. A more complete understanding can be obtained by reference to the following detailed description and to the attached drawings.

### BRIEF DESCRIPTION OF THE DRAWINGS

FIGS. 1A and 1B are views depicting an external appearance of an image capture device according to an example embodiment.

FIGS. 2A and 2B are detailed block diagrams for explaining the internal architecture of the image capture device shown in FIG. 1 according to an example embodiment.

FIG. 3 is a view for explaining an image capture module according to one example embodiment.

FIG. 4 is a view for explaining image capture according to an example embodiment.

FIG. 5 is a view for explaining image capture according to another example embodiment.

FIG. 6 is a flow diagram for explaining enhanced resolution image capture according to an example embodiment.

FIG. 7 is a diagram depicting a cross-sectional view of a stack of microlens arrays such as a Gabor superlens.

### DETAILED DESCRIPTION

In the following example embodiments, there is described a digital camera which may be a digital still camera or a digital video camera. It is understood, however, that the following description encompasses arbitrary arrangements which can incorporate or utilize imaging assemblies with reconfigurable soft optics, for instance, a data processing apparatus having an image sensing function (e.g., a personal computer) or a portable terminal having an image sensing function (e.g., a mobile telephone), a video camera, a microscope or an endoscope.

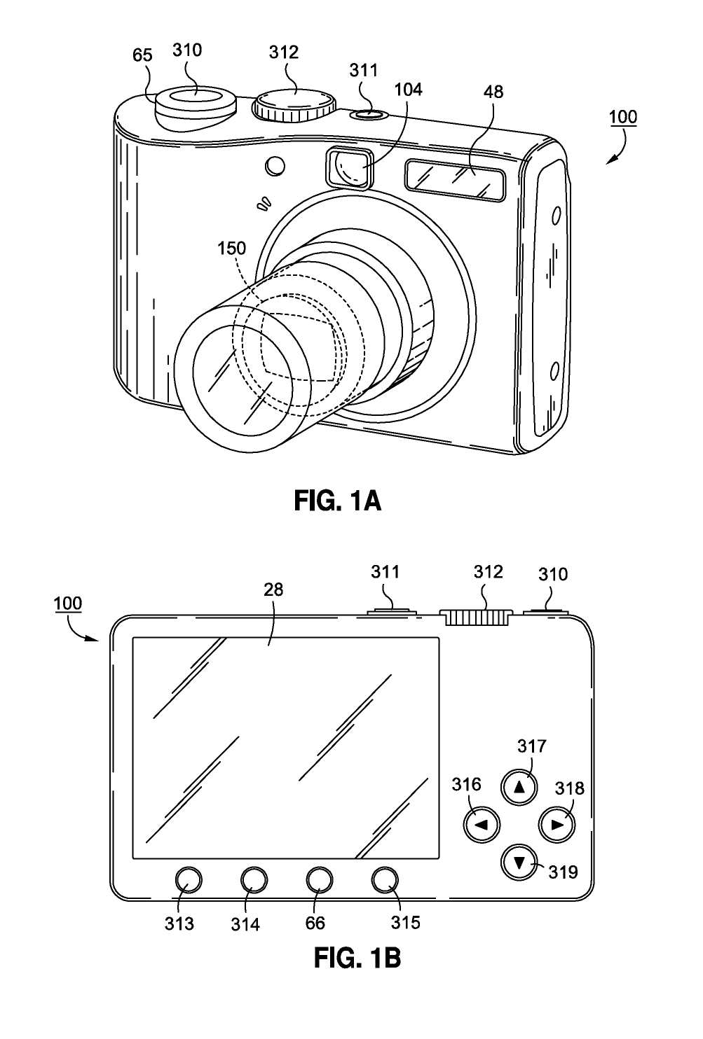

FIGS. 1A and 1B are views showing an example of an external appearance of an image capture device 100 according to an example embodiment. Note that in these figures, some components are omitted for conciseness. A user operates buttons and switches 310 to 319 for turning ON/OFF the power of the digital camera 100, for setting, changing or confirming the shooting parameters, for confirming the status of the camera, and for confirming shot images.

Optical finder 104 is a viewfinder, through which a user can view a scene to be captured. In this embodiment optical finder 104 is separate from image display unit 28, but in some embodiments image display unit 28 may also function as a viewfinder.

Flash (flash emission device) 48 is for emitting auxiliary light to illuminate a scene to be captured, if necessary.

Reconfigurable soft optics 150 are optics which allow reconfiguration of characteristics of image capture without significant reconfiguration of the physical capture hardware. In such systems, for example, one item of capture hardware can be reconfigured for multiple different configurations, such as multiple different optical properties controlled by application of a configuration parameter to the item of capture hardware. Put another way, reconfigurable soft optics 150 provide one generic piece (or system) of hardware for image capture, which can be reconfigured for different applications such as resolution, frame rules, or light-field data. Furthermore, the existing hardware can be reconfigured in a way that facilitates or enables software to perform functions which were previously performed by lens hardware only.

In one example, reconfigurable soft optics 150 might include an optical element comprising a stack of microlens arrays (e.g., stacks of arrays of tiny lenses). In that regard, a microlens array may comprise closely packed lens structures arranged in a particular geometry (rectangular, honeycomb, quincunx, etc.), where the lens size is small in comparison to the thickness of the supporting substrate. Stacks of microlens arrays are ordinarily useful because of their small size and ability to capture a relatively larger amount of image data than a standard lens.

One example of a stack of microlens arrays is a Gabor superlens, in which two microlens arrays act as a camera array. A Gabor superlens was described a UK patent in the 1940's, namely GB541753, and was built and benchmarked in 1999. The Gabor superlens generally has a useful form factor, as it provides a substantially flat zoom lens in addition to a substantially flat lens. Moreover, the Gabor superlens can capture different views of the image at different points, leading to additional data and/or perspectives such as various zooms and depths for image processing. Additionally, the Gabor superlens can be advantageously combined with a spatial light modulator to achieve certain lens effects. However, as mentioned above, the Gabor superlens can tend to have poor resolution, and may in fact have resolution that is inhomogeneous across the field of view, in addition to other aberrations. Accordingly, the present disclosure describes generating a synthesized image has improved image characteristics, as discussed more fully below.

It should be understood that the Gabor superlens is only one example of a stack of microlens arrays, and that other arrangements are possible. For example, while the Gabor superlens or other stacks of microlens arrays generally include two microlens arrays, it might be possible to include three or more microlens arrays, for example to correct lens abberations from the first two stacks.

In some cases, the stack of microlens arrays itself might not be not reconfigurable, but in such cases it can still be used in reconfigurable soft optics 150 by combining it with other items of capture hardware which are reconfigurable. In other cases, the stack of microlens arrays is itself reconfigurable.

Reconfigurable soft optics 150 includes other hardware for image capture, and such other hardware might itself be reconfigurable or might not be reconfigurable. Examples of such other hardware include a visible light lens or lenses, which may include a zoom lens, a shutter having an aperture function, and one or more image sensors. Other examples of such hardware include a flip mirror and a half-silvered mirror, for creating two different optical paths, as explained in greater detail below.

The power button 311 is provided to start or stop the digital camera 100, or to turn ON/OFF the main power of the digital camera 100. The menu button 313 is provided to display the setting menu such as shooting parameters and operation modes of the digital camera 100, and to display the status of the digital camera 100. The menu includes selectable items or items whose values are variable.

A delete button 315 is pressed for deleting an image displayed on a playback mode or a shot-image confirmation screen. In the present embodiment, the shot-image confirmation screen (a so-called quick review screen) is provided to display a shot image on the image display unit 28 immediately after shooting for confirming the shot result. Furthermore, the present embodiment is constructed in a way that the shot-image confirmation screen is displayed as long as a user keeps pressing the shutter button 310 after the user instructs shooting by shutter button depression.

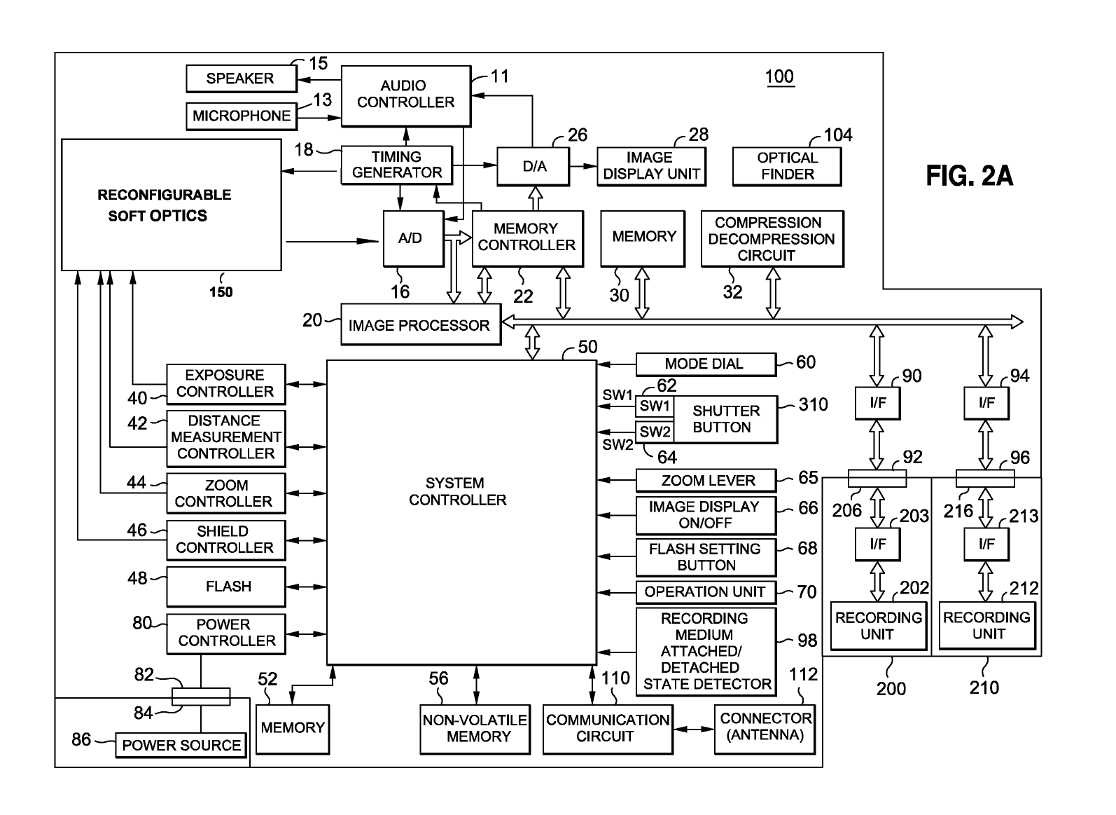

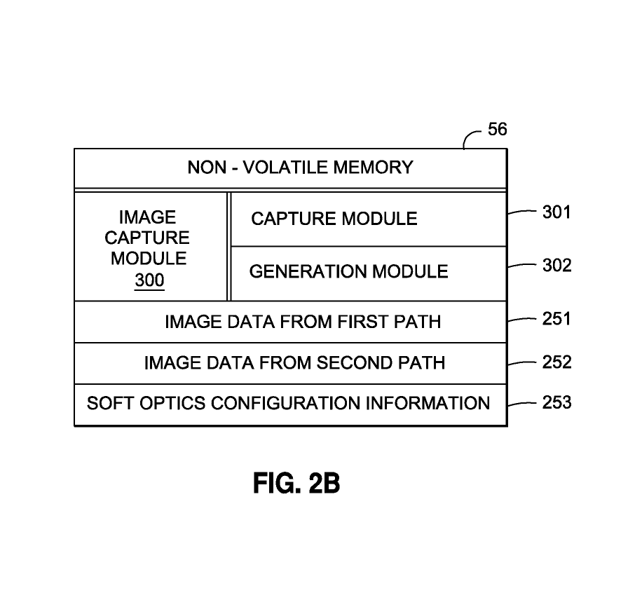

An enter button 314 is pressed for selecting a mode or an item. When the enter button 314 is pressed, the system controller 50 in FIG. 2A sets the mode or item selected at this time. The display ON/OFF button 66 is used for selecting displaying or non-displaying of photograph information regarding the shot image, and for switching the image display unit 28 to be functioned as an electronic view finder.

A left button 316, a right button 318, an up button 317, and a down button 319 may be used for the following purposes, for instance, changing an option (e.g., items, images) selected from plural options, changing an index position that specifies a selected option, and increasing or decreasing numeric values (e.g., correction value, date and time).

Half-stroke of the shutter button 310 instructs the system controller 50 to start, for instance, AF processing, AE processing, AWB processing, EF processing or the like. Full-stroke of the shutter button 310 instructs the system controller 50 to perform shooting.

The zoom operation unit 65 is operated by a user for changing the angle of view (zooming magnification or shooting magnification).

A recording/playback selection switch 312 is used for switching a recording mode to a playback mode, or switching a playback mode to a recording mode. Note, in place of the above-described operation system, a dial switch may be adopted or other operation systems may be adopted.

FIG. 2A is a block diagram showing an example of the arrangement of the digital camera 100 as an image capture device according to this embodiment. Referring to FIG. 2, reference numeral 16 denotes an A/D converter which converts an analog signal from one or more image sensors into a digital signal. The A/D converter 16 is used when an analog signal output from the image sensor(s) is converted into a digital signal and when an analog signal output from an audio controller 11 is converted into a digital signal.

As discussed above, reconfigurable soft optics 150 are optics which allow reconfiguration of characteristics of image capture without significant reconfiguration of the physical capture hardware. As indicated above, reconfigurable soft optics 150 will, in many embodiments, include a microlens array, a visible light lens or lenses which might include a zoom lens, and an image sensor or sensors. In addition, as indicated above, reconfigurable soft optics 150 will, in many embodiments, include a flip mirror assembly and/or a half-silvered mirror, or other optics for creating two or more different optical paths. Various hardware elements of reconfigurable soft optics 150 are and are not reconfigurable under control of system controller 50, in accordance with configuration information stored in memory such as non-volatile memory 56, as explained in greater detail below.

A light beam (light beam incident upon the angle of view of the lens) from an object in a scene impinges on reconfigurable soft optics 150 and two or more images of the object are captured by the image sensor(s) through respective ones of two or more different optical paths. The image sensor(s) convert the optical image to analog image signals and outputs the signals to an A/D converter 16. The A/D converter 16 converts the analog image signals to digital image signals (image data). The image sensor(s) and the A/D converter 16 are controlled by clock signals and control signals provided by a timing generator 18. The timing generator 18 is controlled by a memory controller 22 and a system controller 50.

Reference numeral 18 denotes a timing generator, which supplies clock signals and control signals to the image sensor(s), the audio controller 11, the A/D converter 16, and a D/A converter 26. The timing generator 18 is controlled by a memory controller 22 and system controller 50. Reference numeral 20 denotes an image processor, which applies resize processing such as predetermined interpolation and reduction, and color conversion processing to data from the A/D converter 16 or that from the memory controller 22. The image processor 20 executes predetermined arithmetic processing using the captured image data, and the system controller 50 executes exposure control and ranging control based on the obtained arithmetic result.

As a result, TTL (through-the-lens) AF (auto focus) processing, AE (auto exposure) processing, and EF (flash pre-emission) processing are executed. The image processor 20 further executes predetermined arithmetic processing using the captured image data, and also executes TTL AWB (auto white balance) processing based on the obtained arithmetic result. It is understood that in other embodiments, optical finder 104 may be used in combination with the TTL arrangement or in substitution therefor.

Output data from the A/D converter 16 is written in a memory 30 via the image processor 20 and memory controller 22 or directly via the memory controller 22. The memory 30 stores image data captured and converted into digital data by the A/D converter 16, and image data to be displayed on an image display unit 28. The image display unit 28 may be a liquid crystal screen. Note that the memory 30 is also used to store audio data recorded via a microphone 13, still images, movies, and file headers upon forming image files. Therefore, the memory 30 has a storage capacity large enough to store a predetermined number of still image data, and movie data and audio data for a predetermined period of time.

A compression/decompression unit 32 compresses or decompresses image data by adaptive discrete cosine transform (ADCT) or the like. The compression/decompression unit 32 loads captured image data stored in the memory 30 in response to pressing of the shutter 310 as a trigger, executes the compression processing, and writes the processed data in the memory 30. Also, the compression/decompression unit 32 applies decompression processing to compressed image data loaded from a detachable recording unit 202 or 212, as described below, and writes the processed data in the memory 30. Likewise, image data written in the memory 30 by the compression/decompression unit 32 is converted into a file by the system controller 50, and that file is recorded in nonvolatile memory 56 and/or the recording unit 202 or 212, as also described below.

The memory 30 also serves as an image display memory (video memory). Reference numeral 26 denotes a D/A converter, which converts image display data stored in the memory 30 into an analog signal, and supplies that analog signal to the image display unit 28. Reference numeral 28 denotes an image display unit, which makes display according to the analog signal from the D/A converter 26 on the liquid crystal screen 28 of an LCD display. In this manner, image data to be displayed written in the memory 30 is displayed by the image display unit 28 via the D/A converter 26.

The exposure controller 40 controls an unshown shutter (within reconfigurable soft optics 150) having a diaphragm function based on the data supplied from the system controller 50. The exposure controller 40 may also have a flash exposure compensation function by linking up with flash (flash emission device) 48. The flash 48 has an AF auxiliary light projection function and a flash exposure compensation function.

The distance measurement controller 42 controls an unshown visible light lens of reconfigurable soft optics 150 based on the data supplied from the system controller 50. A zoom controller 44 controls zooming of an unshown zoom lens of reconfigurable soft optics 150. A shield controller 46 controls the operation of an unshown shield (barrier) of reconfigurable soft optics 150 to protect it.

Reference numeral 13 denotes a microphone. An audio signal output from the microphone 13 is supplied to the A/D converter 16 via the audio controller 11 which includes an amplifier and the like, is converted into a digital signal by the A/D converter 16, and is then stored in the memory 30 by the memory controller 22. On the other hand, audio data is loaded from the memory 30, and is converted into an analog signal by the D/A converter 26. The audio controller 11 drives a speaker 15 according to this analog signal, thus outputting a sound.

A nonvolatile memory 56 is an electrically erasable and recordable memory, and uses, for example, an EEPROM. The nonvolatile memory 56 stores constants, computer-executable programs, and the like for operation of system controller 50. Note that the programs include those for execution of various flowcharts.

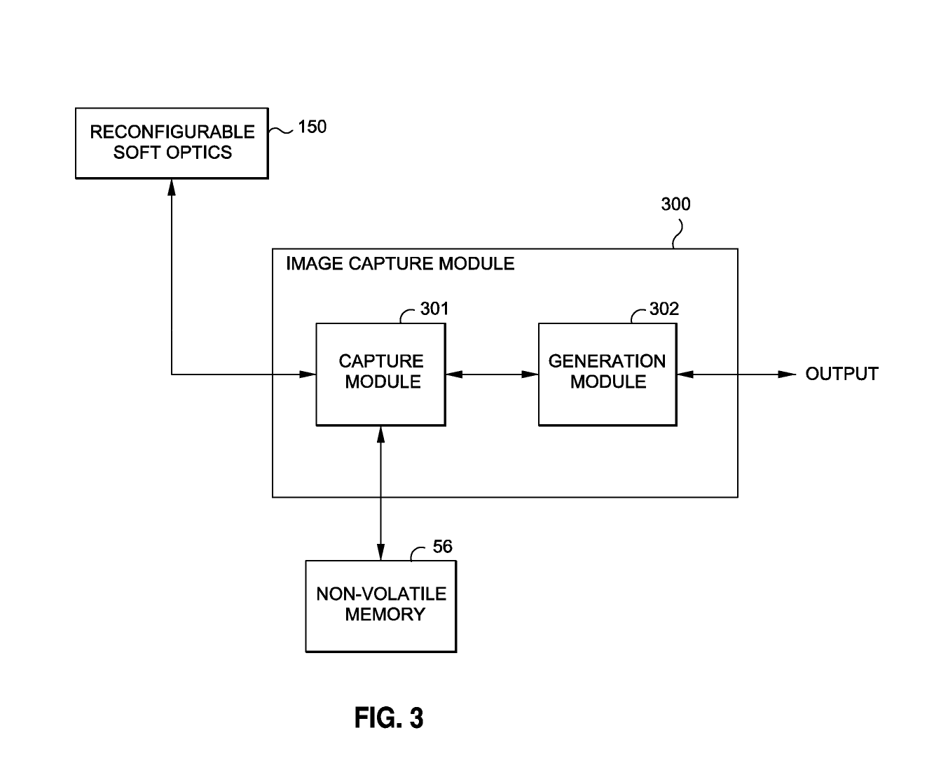

In particular, as shown in FIG. 2B, non-volatile memory 56 is an example of a non-transitory computer-readable memory medium, having retrievably stored thereon image capture module 300 as described herein. According to this example embodiment, the image capture module 300 includes at least a capture module 301 for capturing first and second images of a scene using respectively different first and second optical paths. The first optical path may include an optical element comprising a stack of microlens arrays, such as in reconfigurable soft optics 150. Image capture module 300 may further include a generation module 302 for generating a synthesized image of the scene by calculations using the first and second captured images of the scene, such that the synthesized image has improved image characteristics as compared to both of the first captured image and the second captured image. These modules will be discussed in more detail below with respect to FIG. 3.

Additionally, as shown in FIG. 2B, non-volatile memory 56 also includes image data 251 from a first optical path, and image data 252 from a second optical path different from the first path (although both paths ordinarily capture the same scene). Soft optics configuration information 253 stores control information for configuring reconfigurable soft optics 150 so as to capture different image characteristics. Each of these elements will be described more fully below.

Reference numeral 50 denotes a system controller, which controls the entire digital camera 100. The system controller 50 executes programs recorded in the aforementioned nonvolatile memory 56 to implement respective processes to be described later of this embodiment. Reference numeral 52 denotes a system memory which comprises a RAM. On the system memory 52, constants and variables required to operate system controller 50, programs read out from the nonvolatile memory 56, and the like are mapped.

A mode selection switch 60, shutter switch 310, and operation unit 70 form operation means used to input various operation instructions to the system controller 50.

The mode selection switch 60 includes the imaging/playback selection switch, and is used to switch the operation mode of the system controller 50 to one of a still image recording mode, movie recording mode, playback mode, and the like.

The shutter switch 62 is turned on in the middle of operation (half stroke) of the shutter button 310 arranged on the digital camera 100, and generates a first shutter switch signal SW1. Also, the shutter switch 64 is turned on upon completion of operation (full stroke) of the shutter button 310, and generates a second shutter switch signal SW2. The system controller 50 starts the operations of the AF (auto focus) processing, AE (auto exposure) processing, AWB (auto white balance) processing, EF (flash pre-emission) processing, and the like in response to the first shutter switch signal SW1. Also, in response to the second shutter switch signal SW2, the system controller 50 starts a series of processing (shooting) including the following: processing to read image signals from the image sensor(s) of reconfigurable soft optics 150, convert the image signals into image data by the A/D converter 16, process the image data by the image processor 20, and write the data in the memory 30 through the memory controller 22; and processing to read the image data from the memory 30, compress the image data by the compression/decompression circuit 32, and write the compressed image data in non-volatile memory 56, and/or in recording medium 200 or 210.

A zoom operation unit 65 is an operation unit operated by a user for changing the angle of view (zooming magnification or shooting magnification). The operation unit 65 can be configured with, e.g., a slide-type or lever-type operation member, and a switch or a sensor for detecting the operation of the member.

The image display ON/OFF switch 66 sets ON/OFF of the image display unit 28. In shooting an image with the optical finder 104, the display of the image display unit 28 configured with a TFT, an LCD or the like may be turned off to cut the power supply for the purpose of power saving.

The flash setting button 68 sets and changes the flash operation mode. In this embodiment, the settable modes include: auto, flash-on, red-eye reduction auto, and flash-on (red-eye reduction). In the auto mode, flash is automatically emitted in accordance with the lightness of an object. In the flash-on mode, flash is always emitted whenever shooting is performed. In the red-eye reduction auto mode, flash is automatically emitted in accordance with lightness of an object, and in case of flash emission the red-eye reduction lamp is always emitted whenever shooting is performed. In the flash-on (red-eye reduction) mode, the red-eye reduction lamp and flash are always emitted.

The operation unit 70 comprises various buttons, touch panels and so on. More specifically, the operation unit 70 includes a menu button, a set button, a macro selection button, a multi-image reproduction/repaging button, a single-shot/serial shot/self-timer selection button, a forward (+) menu selection button, a backward (−) menu selection button, and the like. Furthermore, the operation unit 70 may include a forward (+) reproduction image search button, a backward (−) reproduction image search button, an image shooting quality selection button, an exposure compensation button, a date/time set button, a compression mode switch and the like.

The compression mode switch is provided for setting or selecting a compression rate in JPEG (Joint Photographic Expert Group) compression, recording in a RAW mode and the like. In the RAW mode, analog image signals outputted by the image sensing device are digitalized (RAW data) as is and recorded.

Note in the present embodiment, RAW data includes not only the data obtained by performing A/D conversion on the photoelectrically converted data from the image sensing device, but also the data obtained by performing lossless compression on A/D converted data. Moreover, RAW data indicates data maintaining output information from the image sensing device without a loss. For instance, RAW data is A/D converted analog image signals which have not been subjected to white balance processing, color separation processing for separating luminance signals from color signals, or color interpolation processing. Furthermore, RAW data is not limited to digitalized data, but may be of analog image signals obtained from the image sensing device.

According to the present embodiment, the JPEG compression mode includes, e.g., a normal mode and a fine mode. A user of the digital camera 100 can select the normal mode in a case of placing a high value on the data size of a shot image, and can select the fine mode in a case of placing a high value on the quality of a shot image.

In the JPEG compression mode, the compression/decompression circuit 32 reads image data written in the memory 30 to perform compression at a set compression rate, and records the compressed data in, e.g., the recording medium 200.

In the RAW mode, analog image signals are read in units of line in accordance with the pixel arrangement of an unshown color filter of the image sensor(s), and image data written in the memory 30 through the A/D converter 16 and the memory controller 22 is recorded in non-volatile memory 56, and/or in recording medium 200 or 210.

The digital camera 100 according to the present embodiment has a plural-image shooting mode, where plural image data can be recorded in response to a single shooting instruction by a user. Image data recording in this mode includes image data recording typified by an auto bracket mode, where shooting parameters such as white balance and exposure are changed step by step. It also includes recording of image data having different post-shooting image processing contents, for instance, recording of plural image data having different data forms such as recording in a JPEG form or a RAW form, recording of image data having the same form but different compression rates, and recording of image data on which predetermined image processing has been performed and has not been performed.

A power controller 80 comprises a power detection circuit, a DC-DC converter, a switch circuit to select the block to be energized, and the like. The power controller 80 detects the existence/absence of a power source, the type of the power source, and a remaining battery power level, controls the DC-DC converter based on the results of detection and an instruction from the system controller 50, and supplies a necessary voltage to the respective blocks for a necessary period. A power source 86 is a primary battery such as an alkaline battery or a lithium battery, a secondary battery such as an NiCd battery, an NiMH battery or an Li battery, an AC adapter, or the like. The main unit of the digital camera 100 and the power source 86 are connected by connectors 82 and 84 respectively comprised therein.

The recording media 200 and 210 comprise: recording units 202 and 212 that are configured with semiconductor memories, magnetic disks and the like, interfaces 203 and 213 for communication with the digital camera 100, and connectors 206 and 216. The recording media 200 and 210 are connected to the digital camera 100 through connectors 206 and 216 of the media and connectors 92 and 96 of the digital camera 100. To the connectors 92 and 96, interfaces 90 and 94 are connected. The attached/detached state of the recording media 200 and 210 is detected by a recording medium attached/detached state detector 98.

Note that although the digital camera 100 according to the present embodiment comprises two systems of interfaces and connectors for connecting the recording media, a single or plural arbitrary numbers of interfaces and connectors may be provided for connecting a recording medium. Further, interfaces and connectors pursuant to different standards may be provided for each system.

For the interfaces 90 and 94 as well as the connectors 92 and 96, cards in conformity with a standard, e.g., PCMCIA cards, compact flash (CF) (registered trademark) cards and the like, may be used. In this case, connection utilizing various communication cards can realize mutual transfer/reception of image data and control data attached to the image data between the digital camera and other peripheral devices such as computers and printers. The communication cards include, for instance, a LAN card, a modem card, a USB card, an IEEE 1394 card, a P1284 card, an SCSI card, and a communication card for PHS or the like.

The optical finder 104 is configured with, e.g., a TTL finder, which forms an image utilizing prisms and mirrors. By utilizing the optical finder 104, it is possible to shoot an image without utilizing an electronic view finder function of the image display unit 28. The optical finder 104 includes indicators, which constitute part of image display unit 28, for indicating, e.g., a focus state, a camera shake warning, a flash charge state, a shutter speed, an f-stop value, and exposure compensation.

A communication circuit 110 provides various communication functions such as USB, IEEE 1394, P1284, SCSI, modem, LAN, RS232C, and wireless communication. To the communication circuit 110, a connector 112 can be connected for connecting the digital camera 100 to other devices, or an antenna can be provided for wireless communication.

A real-time clock (RTC, not shown) may be provided to measure date and time. The RTC holds an internal power supply unit independently of the power supply controller 80, and continues time measurement even when the power supply unit 86 is OFF. The system controller 50 sets a system timer using a date and time obtained from the RTC at the time of activation, and executes timer control.

FIG. 3 is a view for explaining an image capture module according to one example embodiment. As previously discussed with respect to FIG. 2B, image capture module 300 comprises computer-executable process steps stored on a non-transitory computer-readable storage medium, such as non-volatile memory 56. More or less modules may be used, and other architectures are possible.

As shown in FIG. 3, image capture module 300 at least a capture module 301 for capturing first and second images of a scene using respectively different first and second optical paths. To that end, capture module 301 communicates with reconfigurable soft optics 150, to gather image data from a scene. In that regard, data may be transmitted to the first or second optical paths based on action of a flip mirror, or through a half-silvered mirror, as described more fully below. Capture module 301 may also communicate with non-volatile memory 56 to store images captured via the first or second optical paths, particularly in the case of iterative convolution of the image data from first and second capture paths as discussed more fully below.

Capture module 301 also communicates with generation module 302, which generates a synthesized image of the scene by calculations using the first and second captured images of the scene from capture module 301, such that the synthesized image has improved image characteristics as compared to both of the first captured image and the second captured image. Generation module 302 additionally outputs the synthesized image.

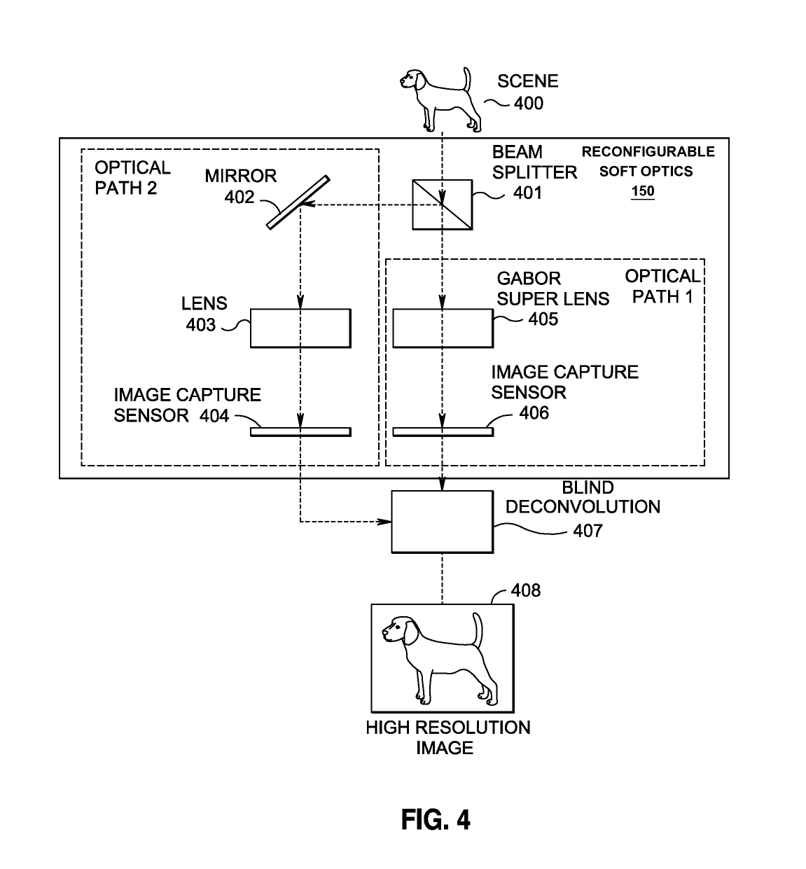

FIG. 4 is a view for explaining image capture according to an example embodiment.

In particular, FIG. 4 depicts an example embodiment of reconfigurable soft optics 150 in which incoming light from scene 400 is split by a half-silvered mirror or beam splitter 401 in a first processing stage, thereby generating a second optical path.

Briefly, optical path 1 includes a stack of microlens arrays (such as a Gabor superlens) 405 and first image sensor 406, whereas optical path 2 includes mirror 402, visible light lens 403 and second image capture sensor 404. The images of both optical paths are captured by two substantially identical imaging sensor arrays 404 and 406. Thus, both the first and second optical paths capture the same field of view, and provide two captures of the same scene 400. The images of both the first and second optical paths are used to compute a final high resolution image 408 using blind deconvolution 407. Blind deconvolution involves recovering the scene from blurred images using multiple algorithms that estimate a point spread function (a response of an imaging system to a light point which, due to practical physical resolution limitations, is not a point but a spatially extended region) from an image set, as discussed more fully below.

At a very high level of abstraction, the frequency information contained in the first and second optical paths, but lost in capture, is filled in to synthesize an image with enhanced resolution relative to the image captured by either one of the first and second optical paths. Put another way, and at a similar high level of abstraction, in the frequency domain, certain high level frequencies might be lost during capture of a single image and become unrecoverable. However, with two images of the same scene with different frequency content, there is ordinarily an opportunity to recover the lost high-frequency signals and use them to generate an improved synthesized image.

In that regard, there is ordinarily no need to have either of the first or second images be of better quality than the other, since recovery is based on the fact that the images are “blurred differently”. For example, in the example above, the resolution of visible light lens 403 need not be better than that of Gabor superlens 405.

Mirror 402 may be incorporated in an assembly such as flip mirror assembly, and, in one embodiment, comprises a rotatable mirror which blocks or allows light, essentially acting as an ON/OFF switch to allow captures of a scene for each lens, at different timings.

In the embodiment shown in FIG. 4, the first optical path is processed by the Gabor superlens 405, which includes, in one example, two stacked microlens arrays in a Kepler configuration (i.e., “positive” or convex microlenses as depicted in FIG. 7). For one example of Gabor superlens 405, and referring to FIG. 7, the pitch p1 of microlens array 1=253 μm, pitch p2 of microlens array 2=251.5 μm, focal length f1=500 μm, and focal length f2=625 μm. Naturally, these numbers are simply examples, and other pitches or focal lengths are possible. For example, another Gabor superlens arrangement could have pitch p1=253 μm and pitch p2=253 μm with the same focal length f1=f2=775 μm. In still another example, the Gabor superlens 405 could be in the “Galiliei configuration”, with one positive microlens array with pitch p1=253 μm and focal length f1=440 μm, and with one negative microlens array with pitch p2=250 μm and focal length f2=−850 μm.

Assuming far field imaging (i.e., the distance of the object in the scene to the Gabor superlens 405 is very large), one can determine the focal length of the Gabor superlens 405 using the following equation:

$${F}_{super} = {f}_{1} \frac{{p}_{2}}{( {p}_{1} - {p}_{2} )}$$

Given the parameters of the exemplary Gabor superlens parameters of p1=253 μm, p2=251.5 μm and f1=500 μm, and assuming that light from the object passes first through the microlens array with pitch p1, the effective focal length of the Gabor superlens 405 is 83.83 mm. Of course, the disclosure is not confined to far field imaging, and the above is intended only as an example.

Meanwhile, optical path 2 uses mirror 402 to reflect light from scene 400 to visible light lens 403. In one embodiment, the focal length of the Gabor superlens 405 is matched by the lens 403 in the second optical path. Thus, the Gabor superlens 405 and the lens 403 will have substantially the same viewing angle.

In an alternative embodiment the focal length of the lens 403 in the second optical path can differ from the focal length of the Gabor superlens 405. In that case, the resolution of the image sensor 404 in the second optical path has to match the focal length of the lens 403 in the second optical path such that both the first and the second optical path capture the same field of view. Put another way, the pixels can be made smaller to get the same field of view despite the different focal lengths.

In yet another alternative embodiment, one or two tunable microlens arrays comprised of e.g. liquid crystal lenslets are used in the Gabor superlens setup, such that the focal length can be varied.

In still another alternative embodiment, lens 403 could also be a Gabor superlens, but with a different configuration than Gabor superlens 405. In this regard, if the Gabor superlens is configurable or tunable as discussed above, one embodiment might capture one image, change the microlens array configuration, and then capture the second image. Of course, lens 403 could also be embodied as a standard imaging lens.

At the next stage of the processing, the images of both the first and the second optical paths are captured using first and second imaging sensor arrays 404 and 406, which may be identical. If the first and second image sensor arrays 404 and 406 are identical, the first and the second optical path capture both the same field of view.

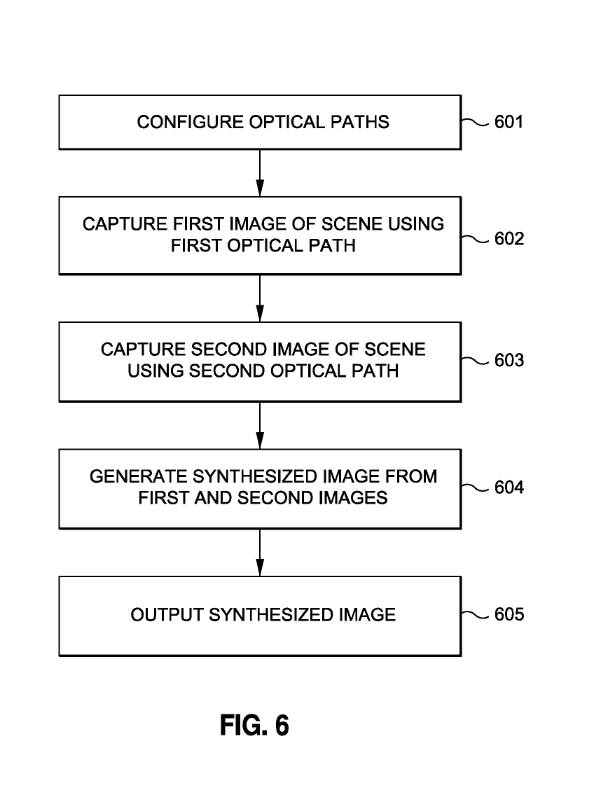

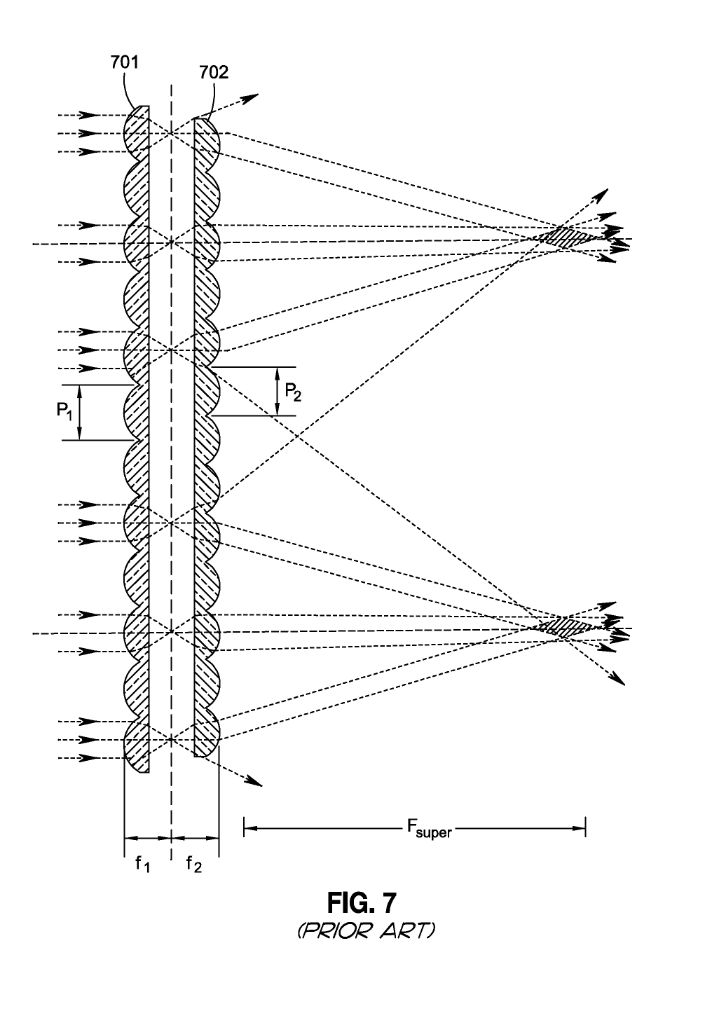

Then, the images of both the first and second optical paths are used to compute a final high resolution image 408 using blind deconvolution 407, as discussed more fully below with respect to FIG. 6.

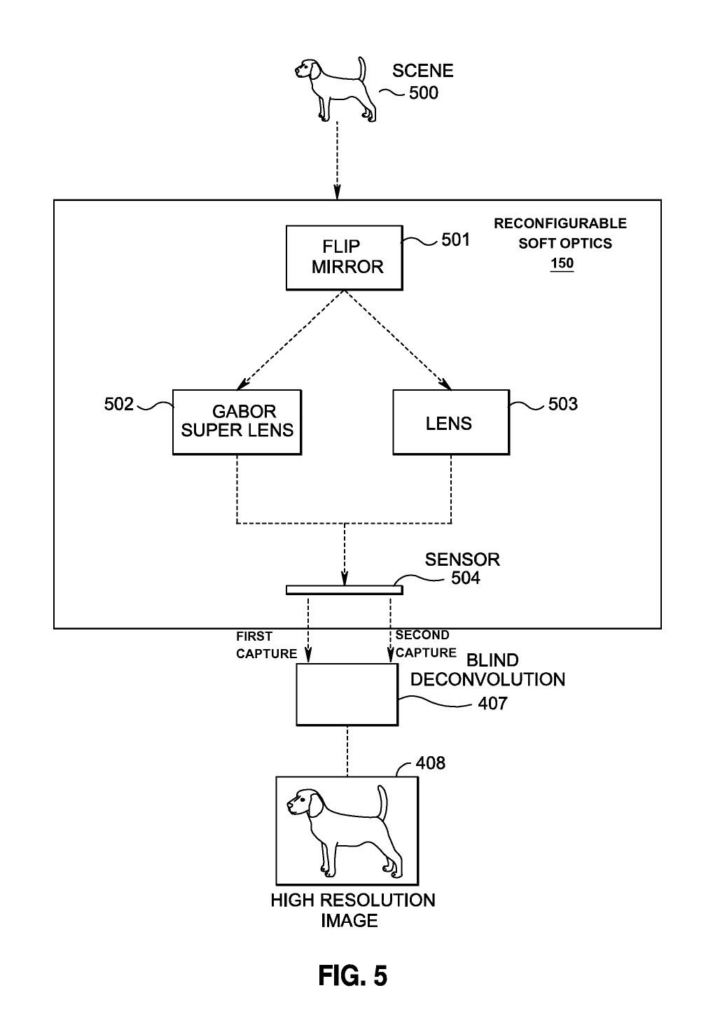

Meanwhile, turning to FIG. 5, FIG. 5 is a view for explaining image capture according to another example embodiment.

In particular, FIG. 5 depicts an embodiment for reconfigurable soft optics 150 in which only one image sensor is used, and in which images of scene 500 are blocked/allowed to Gabor superlens 502 or lens 503 by a flip mirror 501 (e.g., part of a flip mirror assembly). Thus, the first and second optical paths are time-sequentially generated by performing two captures at different timings with the same sensor 504. Preferably, the timing of these two captures is closely-spaced, so that there is less chance of significant movement in the scene as between the two captures (unless the motion in the real-world scene is slow or nonexistent, in which case a longer timing between captures might be acceptable). The physical construction of the Gabor superlens 502 and lens 503 can be similar to those discussed above with respect to FIG. 4, including the discussion of alternatives.

FIG. 6 is a flow diagram for explaining enhanced resolution image capture according to an example embodiment.

Briefly, in FIG. 6, first and second images of a scene are captured using respectively different first and second optical paths. The first optical path includes an optical element comprising a stack of microlens arrays. A synthesized image of the scene is generated by calculations using the first and second captured images of the scene. The synthesized image has improved image characteristics as compared to both of the first captured image and the second captured image.

In more detail, in step 601, the first and second optical paths for image capture are configured. For example, the first and second optical paths may be configured so as to capture two images at the same time using two sensors as shown in FIG. 4, or so as to capture two images at different timings with the same sensor, as shown in FIG. 5. Additionally, aspects of the physical configuration such as the pitch of the lenses, focal length and the like can be configured based on the needs of the user.

In step 602, a first image of a scene is captured using the first optical path (e.g., the path including the stack of microlens arrays).

In step 603, a second image of the scene is captured using the second optical path.

In step 604, a synthesized image is generated from the first and second images. At a very high level of abstraction, the frequency information contained in the each optical path but lost in capture is filled in using information from both captures to enhance the resolution of the synthesized image.

In one example, the synthesized image is generated using blind deconvolution. In particular, a deconvolution can be used by finding the maximum a posteriori explanation x if both the two images y₁ and y₂ from the first and second optical paths, respectively, are observed:

x=arg maxₓ{P(x|(y₁,y₂))=(P(y₁|x)+P(y₂|x))·P(x)}

In one example embodiment, it is assumed that noise in the imaging system is an independent and identically distributed Gaussian variable with a variance of a, such that the probability of observing yᵢ knowing x can be expressed as:

$$P ( {y}_{i} \vert x ) = exp ( - \frac{1}{2 {σ}^{2}} {\vert y - {C}_{i} ( x ) \vert}^{2} )$$

In the above equation, Cᵢ denotes the blur introduced by the first and second optical paths (e.g., the respective point spread functions), which are initially unknown. In this embodiment, however, the blur functions are initially assumed to be Gaussian, and are later refined by reiterating the deconvolution process.

Next, the prior information P(x) is chosen to be suitable for natural images, e.g.:

P(x)=exp(−αΣ|gᵢⱼ*x|²)

where i sums over the image pixels, and g_{id} denotes a set of filters. For natural images, the filters gᵢⱼ can be the horizontal and the vertical gradient, or any other suitable filter.

Computing the maximum a posteriori explanation x includes inserting P(x) and P(yᵢ|x) into the deconvolution ansatz described above, and taking the logarithms results in finding the resulting high resolution image x by minimizing

∥y₁−C₁x∥²+∥y₂−C₂x∥²+ωΣ∥Gᵢⱼ∥²→min

where the weights ω are determined by parameters of the natural image prior and the noise in the imaging path as ω=ασ. Finding the minimum is done, for example, by taking the derivative as:

$$\frac{d}{d x} \{ {‖ {y}_{1} - {C}_{1} x ‖}^{2} + {‖ {y}_{2} - {C}_{2} x ‖}^{2} + ω \sum {‖ {G}_{ij} x ‖}^{2} \} = 0$$

which results in the linear system

(C₁^{T}y₁+C₂^{T}y₂)=((C₁^{T}C₁+C₂^{T}C₂)−ωΣGᵢⱼ^{T}Gᵢⱼ)x.

In the above, the matrices C₁, C₂ and matrix G_{id} are band matrices. As such,

((C₁^{T}C₁+C₂^{T}C₂)−ωΣGᵢⱼ^{T}Gᵢⱼ)

is a Toeplitz matrix, as well as sparse. Solving this sparse linear system results in the final high resolution output image x.

In that regard, there are many methods to solve a system of linear equations, such as the Gauss-Jordan elimination, the application of Cramer's rule, the LU decomposition or the Levinson recursion (which is vary fast for Toeplitz matrices). In addition, there are various methods to solve sparse systems of linear equations, for example the conjugate gradient method. Thus, the final high resolution output image can be found.

Using the found high resolution output image x and the observed image y₁, a refinement C′₁ (of the blur function C₁) can be computed. Similarly, a refinement C′₂ (of the blur function C₂) can be computed. Using those refined blur functions, the deconvolution process is repeated and a refined output image x′ is generated.

Accordingly, the synthesized image is generated by repeating the deconvolution process.

In an alternative embodiment, the deconvolution is carried out on the first optical path as

x=arg maxₓ{P(x|(y₁))=P(y₁|x))·P(x)}

and the image observed in the second optical path is used to derive the image prior P(x).

Returning to FIG. 6, in step 605, the synthesized image is output.

By virtue of the above arrangements, it is ordinarily possible to augment the image of a stack of microlens arrays such as a Gabor superlens with additional information via another image path, in order to, for example, generate a higher-resolution image.

### Other Embodiments

According to other embodiments contemplated by the present disclosure, example embodiments may include a computer processor such as a single core or multi-core central processing unit (CPU) or micro-processing unit (MPU), which is constructed to realize the functionality described above. The computer processor might be incorporated in a stand-alone apparatus or in a multi-component apparatus, or might comprise multiple computer processors which are constructed to work together to realize such functionality. The computer processor or processors execute a computer-executable program (sometimes referred to as computer-executable instructions or computer-executable code) to perform some or all of the above-described functions. The computer-executable program may be pre-stored in the computer processor(s), or the computer processor(s) may be functionally connected for access to a non-transitory computer-readable storage medium on which the computer-executable program or program steps are stored. For these purposes, access to the non-transitory computer-readable storage medium may be a local access such as by access via a local memory bus structure, or may be a remote access such as by access via a wired or wireless network or Internet. The computer processor(s) may thereafter be operated to execute the computer-executable program or program steps to perform functions of the above-described embodiments.

According to still further embodiments contemplated by the present disclosure, example embodiments may include methods in which the functionality described above is performed by a computer processor such as a single core or multi-core central processing unit (CPU) or micro-processing unit (MPU). As explained above, the computer processor might be incorporated in a stand-alone apparatus or in a multi-component apparatus, or might comprise multiple computer processors which work together to perform such functionality. The computer processor or processors execute a computer-executable program (sometimes referred to as computer-executable instructions or computer-executable code) to perform some or all of the above-described functions. The computer-executable program may be pre-stored in the computer processor(s), or the computer processor(s) may be functionally connected for access to a non-transitory computer-readable storage medium on which the computer-executable program or program steps are stored. Access to the non-transitory computer-readable storage medium may form part of the method of the embodiment. For these purposes, access to the non-transitory computer-readable storage medium may be a local access such as by access via a local memory bus structure, or may be a remote access such as by access via a wired or wireless network or Internet. The computer processor(s) is/are thereafter operated to execute the computer-executable program or program steps to perform functions of the above-described embodiments.

The non-transitory computer-readable storage medium on which a computer-executable program or program steps are stored may be any of a wide variety of tangible storage devices which are constructed to retrievably store data, including, for example, any of a flexible disk (floppy disk), a hard disk, an optical disk, a magneto-optical disk, a compact disc (CD), a digital versatile disc (DVD), micro-drive, a read only memory (ROM), random access memory (RAM), erasable programmable read only memory (EPROM), electrically erasable programmable read only memory (EEPROM), dynamic random access memory (DRAM), video RAM (VRAM), a magnetic tape or card, optical card, nanosystem, molecular memory integrated circuit, redundant array of independent disks (RAID), a nonvolatile memory card, a flash memory device, a storage of distributed computing systems and the like. The storage medium may be a function expansion unit removably inserted in and/or remotely accessed by the apparatus or system for use with the computer processor(s).

This disclosure has provided a detailed description with respect to particular representative embodiments. It is understood that the scope of the appended claims is not limited to the above-described embodiments and that various changes and modifications may be made without departing from the scope of the claims.

What is claimed is:

1. An image capture method comprising:
capturing first and second images of a scene using respectively different first and second optical paths, wherein the first optical path includes an optical element comprising a stack of microlens arrays; and
generating a synthesized image of the scene by calculations using the first and second captured images of the scene, wherein the synthesized image has improved image characteristics as compared to both of the first captured image and the second captured image.

2. An image capture method according to claim 1, wherein the first and second optical paths are defined by a beam splitter which splits the first and second optical paths into physically different optical paths.

3. An image capture method according to claim 2, wherein the first and second captured images are captured by image sensors provided uniquely for each of the first and second optical paths.

4. An image capture method according to claim 1, wherein one of the first and second optical paths includes an optical element comprising reconfigurable soft optics.

5. An image capture method according to claim 4, wherein the first and second optical paths are defined by different configurations of the reconfigurable soft optics.

6. An image capture method according to claim 4, wherein the first and second captured images are captured in succession by an image sensor used commonly for both of the first and second optical paths.

7. An image capture method according to claim 1, wherein the second optical path includes an optical element comprising an optical imaging lens having refractive power.

8. An image capture method according to claim 1, wherein the focal length of the first optical path is matched by the focal length of the second optical path.

9. An image capture method according to claim 1, wherein the focal length of the first optical path differs from the focal length of the second optical path.

10. An image capture method according to claim 1, wherein one or both of the first optical path and the second optical path have variable focal length.

11. An image capture method according to claim 1, wherein generation of the synthesized image comprises blind deconvolution of the first and second captured images.

12. An image capture method according to claim 11, wherein blind deconvolution is applied to the first and second captured images iteratively.

13. An image capture method according to claim 1, wherein generation of the synthesized image comprises deconvolution using natural image priors applied to the first and second captured images.

14. An image capture method according to claim 1, wherein the synthesized image has improved spatial resolution as compared to both of the first captured image and the second captured image.

15. An image capture method according to claim 1, wherein the resolution of the second optical path is worse than the resolution of the first optical path.

16. An image capture method according to claim 1, wherein the first and second optical paths are configured such that the first and second captured images have relatively different frequency content.

17. An image capture apparatus, comprising:
a computer-readable memory constructed to store computer-executable process steps; and
a processor constructed to execute the computer-executable process steps stored in the memory;
wherein the process steps stored in the memory cause the processor to:
capture first and second images of a scene using respectively different first and second optical paths, wherein the first optical path includes an optical element comprising a stack of microlens arrays; and
generate a synthesized image of the scene by calculations using the first and second captured images of the scene, wherein the synthesized image has improved image characteristics as compared to both of the first captured image and the second captured image.

18. An image capture apparatus according to claim 17, wherein the first and second optical paths are defined by a beam splitter which splits the first and second optical paths into physically different optical paths.

19. An image capture apparatus according to claim 18, wherein the first and second captured images are captured by image sensors provided uniquely for each of the first and second optical paths.

20. An image capture apparatus according to claim 17, wherein one of the first and second optical paths includes an optical element comprising reconfigurable soft optics.

21. An image capture apparatus according to claim 20, wherein the first and second optical paths are defined by different configurations of the reconfigurable soft optics.

22. An image capture apparatus according to claim 20, wherein the first and second captured images are captured in succession by an image sensor used commonly for both of the first and second optical paths.

23. An image capture apparatus according to claim 17, wherein the second optical path includes an optical element comprising an optical imaging lens having refractive power.

24. An image capture apparatus according to claim 17, wherein the focal length of the first optical path is matched by the focal length of the second optical path.

25. An image capture apparatus according to claim 17, wherein the focal length of the first optical path differs from the focal length of the second optical path.

26. An image capture apparatus according to claim 17, wherein one or both of the first optical path and the second optical path have variable focal length.

27. An image capture apparatus according to claim 17, wherein generation of the synthesized image comprises blind deconvolution of the first and second captured images.

28. An image capture method according to claim 27, wherein blind deconvolution is applied to the first and second captured images iteratively.

29. An image capture apparatus according to claim 17, wherein generation of the synthesized image comprises deconvolution using natural image priors applied to the first and second captured images.

30. An image capture apparatus according to claim 17, wherein the synthesized image has improved spatial resolution as compared to both of the first captured image and the second captured image.

31. An image capture apparatus according to claim 17, wherein the resolution of the second optical path is worse than the resolution of the first optical path.

32. An image capture apparatus according to claim 17, wherein the first and second optical paths are configured such that the first and second captured images have relatively different frequency content.

33. An image capture module, comprising:
a capture module for capturing first and second images of a scene using respectively different first and second optical paths, wherein the first optical path includes an optical element comprising a stack of microlens arrays; and
a generation module for generating a synthesized image of the scene by calculations using the first and second captured images of the scene, wherein the synthesized image has improved image characteristics as compared to both of the first captured image and the second captured image.

34. A computer-readable storage medium on which is stored computer-executable process steps for causing a computer to compress data, said process steps comprising:
capturing first and second images of a scene using respectively different first and second optical paths, wherein the first optical path includes an optical element comprising a stack of microlens arrays; and
generating a synthesized image of the scene by calculations using the first and second captured images of the scene, wherein the synthesized image has improved image characteristics as compared to both of the first captured image and the second captured image.
